(19) United States
(12) Patent Application Publication
(10) Pub. No.: US 2005/0057156 A1
(43) Pub. Date: Mar. 17, 2005

(54) Flat lamp

(75) Inventors: Sang-hun Jang, Gyeonggi-do (KR); Hidekazu Hatanaka, Gyeonggi-do (KR); Young-mo Kim, Gyeonggi-do (KR); Seong-eui Lee, Gyeonggi-do (KR); Xiaoqing Zeng, Gyeonggi-do (KR); Seung-hyun Son, Gyeonggi-do (KR); Gi-young Kim, Chungcheongbuk-do (KR); Hyoung-bin Park, Gyeonggi-do (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Gyeonggi-do (KR)

(21) Appl. No.: 10/940,613

(22) Filed: Sep. 15, 2004

(30) Foreign Application Priority Data
Sep. 17, 2003 (KR) 10-2003-0064570

(51) Int. Cl. H01J 1/62; H01J 63/04

(52) U.S. Cl. 313/634; 313/581; 313/495

(57) ABSTRACT

A flat lamp is provided. The provided flat lamp includes an electrode unit generating an electric field in a discharge area between a front plate and a rear plate to generate a gas discharge, and spacers arranged between the front plate and the rear plate while having first portions contacting the inner surface of the front plate or the rear plate and second portions contacting the inner surface of the other plate. The second portions of the spacers extend at least two directions centering around the first portions. A fluorescent material layer is formed on any portion in a discharge area, for example, on the inner surface of the front plate or the inner surface of the rear plate. In the provided flat lamp, visible rays are generated from portions where the spacers are formed. Thus, when the spacers do not absorb nor block ultraviolet rays, the spacers transfer the ultraviolet rays to the fluorescent layer formed on the inner surface of the front plate. In other case, fluorescent layers are formed on the inner surfaces of the spacers that contact the inner spaces of the spacers of generating separate discharges in order to generate visible rays. Accordingly, partial deterioration of luminance and unevenness of luminance are prevented.

### BACKGROUND OF THE INVENTION

This application claims the priority of Korean Patent Application No. 2003-64570, filed on Sep. 17, 2003, in the Korean Intellectual Property Office, the disclosure of which is incorporated herein in its entirety by reference.

1. Field of the Invention

The present invention relates to a flat lamp, and more particularly, to a plasma flat lamp having spacers with an improved structure of maintaining a predetermined gap between a front plate and a rear plate.

2. Description of the Related Art

A flat lamp developed as a back-light of a liquid crystal display (LCD) generates visible rays by exciting a fluorescent material by using ultraviolet rays emitted from a positive column during a plasma discharge. During the plasma discharge, a negative glow of emitting visible rays and the positive column of emitting a large amount of ultraviolet rays are generated in a discharge area. Such an area for the plasma discharge is divided into line units or pixel units by barrier walls between substrates.

A flat lamp is formed in a structure of arranging a discharge gas and discharge electrodes in a discharge area sealed between a front plate and a rear plate that maintain a predetermined distance. Such a flat lamp generates electrons of high temperature that excite neutral gas atoms and particles by generating a plasma discharge using a discharge gas, via applying a voltage to electrodes. Then, the atoms and particles excited by the electrons are fallen to a ground state to generate the ultraviolet rays, and the ultraviolet rays excite a fluorescent material coated on the inner wall of the discharge area to generate the visible rays.

The distance between the front plate and the rear plate of the flat lamp is maintained due to walls located at the edges of the front plate and the rear plate and spacers arranged in the discharge area in which a pressure of lower than the atmosphere pressure is maintained. Here, the spacers are formed in a ball shape, a triangular prism shape, a square prism shape, or a cross column shape. Such spacers are located in the discharge area, resulting in occupying portions of the discharge area and the area to which the fluorescent material is coated. Thus, the area to which the fluorescent material is coated is reduced, and the spacers absorb and block the ultraviolet rays to reduce the amount of energy of exciting the fluorescent material, resulting in reducing a partial luminance. Accordingly, a diffusion area or a diffusion plate is applied to the front plate to uniformly diffuse the light so as to prevent the unevenness of luminance. (M. Ilmer et al., Society for Information Display International Symposium Digest of Technical Papers 31, 931(2000)).

It is inevitable to reduce the unevenness of luminance by using a diffusion area or a diffusion plate; however, the difficulty of designing the diffusion area or the diffusion plate can be reduced by reducing the unevenness of luminance in a luminescence area.

A method of coating a fluorescent material on the surfaces of ball spacers and removing portions of a fluorescent layer from the inner surface of a front plate that correspond to the fluorescent material is disclosed in U.S. Pat. No. 6,531,822. In the method, the fluorescent material emits light by using ultraviolet rays, which are absorbed or blocked by the ball spacers, resulting in reducing partial deterioration of luminance.

On the other hand, a method of using cylinder-shaped spacers on which a fluorescent material is coated to separate a discharge area and to prevent partial deterioration of luminance around the spacers is disclosed in U.S. Laid-open patent No. 20020021564.

Problems to be solved of a flat lamp are preventing a partial decrease in light amount due to spacers located in a discharge area and unevenness of entire luminance, and maximizing the luminescence area in the discharge area.

### SUMMARY OF THE INVENTION

The present invention provides a flat lamp of preventing partial decreases in luminance due to spacers located in a discharge area.

The present invention also provides a flat lamp of efficiently preventing decrease in a luminescence area due to spacers.

According to an aspect of the present invention, there is provided a flat lamp comprising a front plate and a rear plate providing a space of a predetermined gap in which a discharge gas is stored, an electrode unit generating an electric field in a discharge area between the front plate and the rear plate to generate a gas discharge, and spacers arranged between the front plate and the rear plate while having first portions contacting the inner surface of the front plate or the rear plate and second portions contacting the inner surface of the other plate wherein the second portions extend at least two directions centering around the first portions.

The spacers may have inner spaces with an open side and fluorescent layers may be coated on the inner surfaces of the spacers. Each of the spacers may have a section in a semicircular shape or an oval shape that has an open side and an inner space or a section in a polygonal shape that has one open side, one vertex corresponding to the first portion, and the second portions extend from the vertex with a predetermined angle.

The spacers may have a length of crossing the discharge area and may be lined up in the discharge area. In addition, the discharge area between the first plate and the second plate may be divided into a plurality number of areas and the spacers may be arranged in the divided areas.

The spacers may be short and arranged in the discharge area with a predetermined density. In addition, the discharge area between the first plate and the second plate may be divided into a plurality number of areas and the short spacers may be arranged in the divided areas.

The first portions of the spacers may contact the inner surface of the front plate and the second portions of the spacers may contact the inner surface of the rear plate, and a fluorescent layer may be formed on the inner surface of the front plate except for the portions where the first portions of the spacers contact.

The first portions of the spacers may contact the inner surface of the front plate, and a fluorescent layer formed on the inner surface of the front plate may extend to the portions of the inner surface of the front plate that contact the spacers.

### BRIEF DESCRIPTION OF THE DRAWINGS

The above and other features and advantages of the present invention will become more apparent by describing in detail exemplary embodiments thereof with reference to the attached drawings in which:

FIG. 1A is a perspective view illustrating a flat lamp according to a first embodiment of the present invention;

FIG. 1B is a sectional view illustrating the flat lamp of FIG. 1A according to the first embodiment of the present invention;

FIG. 2A is a perspective view illustrating a flat lamp according to a second embodiment of the present invention;

FIG. 2B is a sectional view illustrating the flat lamp of FIG. 2A according to the second embodiment of the present invention;

FIG. 3A is a sectional view illustrating the detailed structure of a spacer of a flat lamp according to the present invention;

FIG. 3B is a sectional view illustrating the optical function of the spacer of FIG. 3A according to the present invention;

FIG. 4 is a sectional view illustrating a flat lamp in which the arranged direction of spacers is changed according to a third embodiment of the present invention;

FIGS. 5A through 5D are sectional views illustrating spacers of various shapes that are applied to a flat lamp according to the present invention;

FIGS. 6A through 6D are sectional views illustrating flat lamps according to the present invention to which ultraviolet rays absorptive spacers are applied;

FIGS. 7 through 11 are sectional views illustrating spacers on which fluorescent layers are coated in three different types to be applied to a flat lamp according to the present invention;

FIGS. 12A and 12B are a perspective view illustrating a long spacer and a plane view illustrating a flat lamp in which the long spacers are arranged according to a fourth embodiment of the present invention;

FIGS. 13A and 13B are a perspective view illustrating a short spacer and a plane view illustrating a flat lamp in which the short spacers are arranged according to a fifth embodiment of the present invention;

FIG. 14A is a plane view illustrating a flat lamp in which the long spacers of FIG. 12A are arranged and a discharge area is separated according to a sixth embodiment of the present invention;

FIG. 14B is a plane view illustrating a flat lamp in which the short spacers of FIG. 13A are arranged and a discharge area is separated according to a seventh embodiment of the present invention; and

FIG. 15 is a graph of comparing the partial luminescence of a conventional flat lamp with the partial luminescence of a flat lamp according to the present invention.

### DETAILED DESCRIPTION OF THE INVENTION

The present invention will now be described more fully with reference to the accompanying drawings, in which exemplary embodiments of the invention are shown. In the description of the present invention, a discharge unit including electrodes in a flat lamp and a method of discharge will not be described, and they will not limit the scope of the present invention. In the present invention, the method of discharge is a conventional method, for example, an AC pulse driving method or a DC pulse driving method. In addition, the detailed structure of the electrodes will not be described in the description of the present invention.

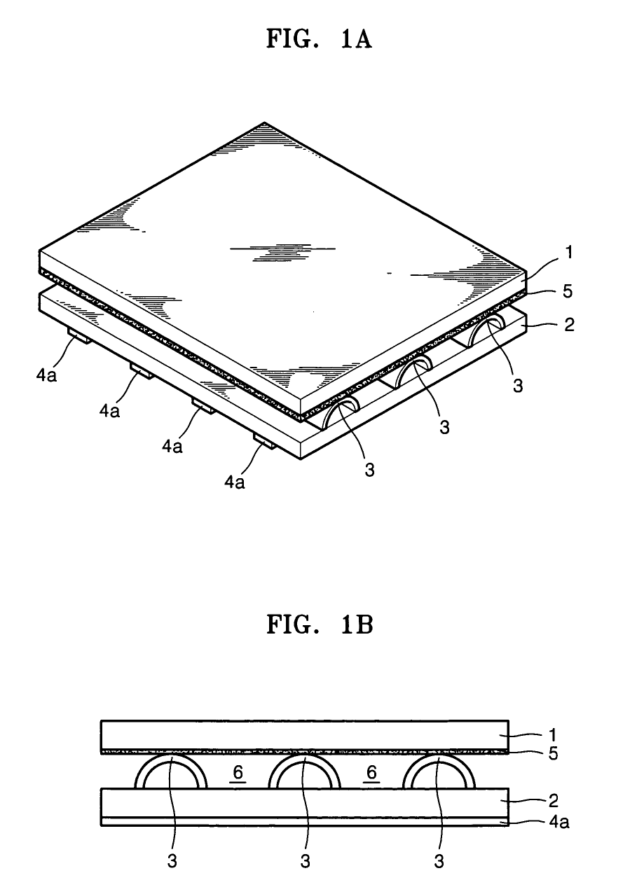

Referring to FIGS. 1A and 1B, a front plate 1 and a rear plate 2, which define a discharge area 6 with a predetermined gap, are separated with a predetermined distance. In addition, optical transmissive spacers 3 with a predetermined length and a semicircular section are lined up between the front plate 1 and the rear plate 2. Here, the spacers 3 are especially transmissive and not absorptive of ultraviolet rays. A plurality of discharge electrodes 4a are lined up on the rear surface of the rear plate 2 in the perpendicular direction to the spacers 3. A fluorescent layer 5 is formed on the inner surface of the front plate 1.

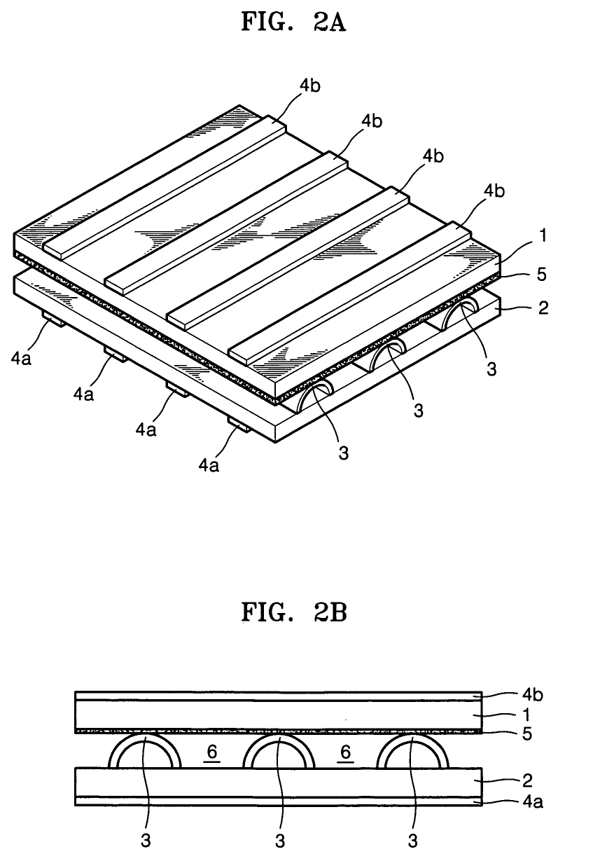

Referring to FIGS. 2A and 2B, a front plate 1 and a rear plate 2, which define a discharge area 6, are separated with a predetermined distance, and a plurality of optical transmissive spacers 3 with a predetermined length and a semicircular section are lined up therebetween. A plurality of discharge electrodes 4a and 4b are lined up on the rear surface of the rear plate 2 and on the front surface of the front plate 1 in the perpendicular direction to the spacers 3. A fluorescent layer 5 is formed on the inner surface of the front plate 1.

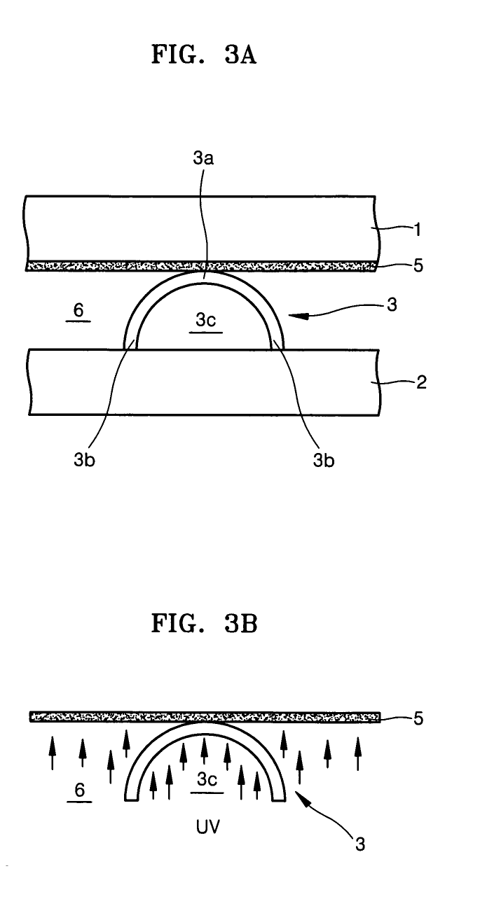

The flat lamps according to the first and second embodiments of the present invention are characterized in that the spacers 3 have a semicircular section. Referring to FIG. 3A, the spacer 3 has a first portion 3a, which is at the top of the spacer 3 and contacts the inner surface of the front plate 1, and second portions 3b, which extend from the first portion 3a and contact the inner surface of the rear plate 2. Thus, the spacer 3 has a space 3c with a semicircular section that concaves toward the rear plate 2. A discharge gas charged between the front plate 1 and the rear plate 2 is introduced to the space 3c to generate a discharge in the space 3c when generating a discharge between the first plate 1 and the rear plate 2. Here, in the case where the spacer 3 is transmissive of ultraviolet rays, ultraviolet rays progress to the portions of the inner surface of the front plate 1 that are overlapped by the spacer 3, as shown in FIG. 3B. Thus, visible rays are generated on the portions of the fluorescent layer 5 that contact or are overlapped by the spacer 3. It is because the space 3c in the spacer 3 and the discharge area 6 at the outside of the spacer 3 are arranged to be overlapped toward the fluorescent layer 5, and the spacer 3 maintains a predetermined gap between the front plate 1 and the rear plate 2.

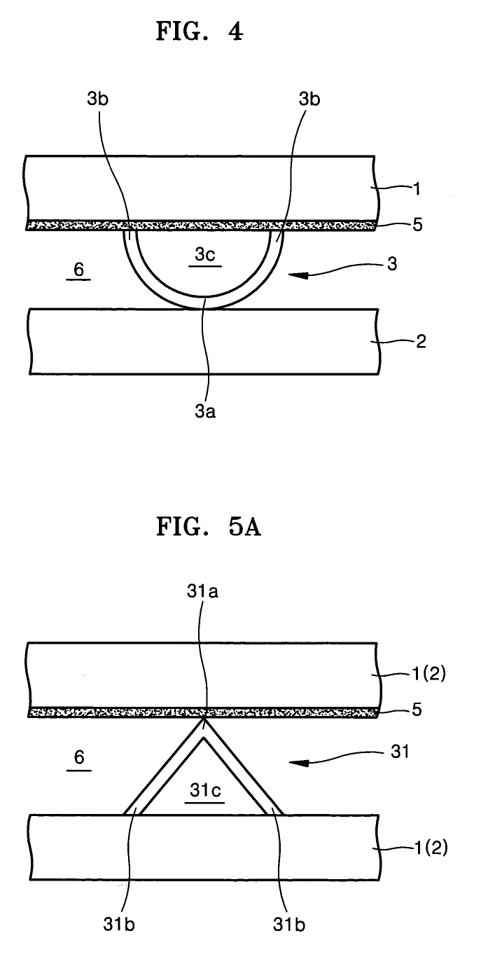

Another example of a spacer 3 for overlapping an inner space 3c and a discharge area 6 at the outside of the spacer 3 is shown in FIG. 4. Referring to FIG. 4, second potions 3b of the semicircular spacer 3 are formed toward the front plate 1 and the first portion 3a of the spacer 3 contacts the inner surface of the rear plate 2. In case of the spacer 3 of FIG. 4, a space 3c in the spacer 3 and a discharge area 6 at the outside of the spacer 3 are overlapped toward a fluorescent layer 5, so that ultraviolet lays reach the entire fluorescent layer 5.

Other than the example of the spacer 3, which is formed by changing the arranging direction of the spacer 3, the spacer 3 can be changed by varying the sectional shape and the length, as long as the spacer 3 provides an inner space 3c. In other words, when the spacer 3 has a first portion contacting a front plate or a rear plate and second portions extending from the first portion and contacting the rear plate or the front plate to form an inner space, the sectional shape and the length of the spacer 3 may vary.

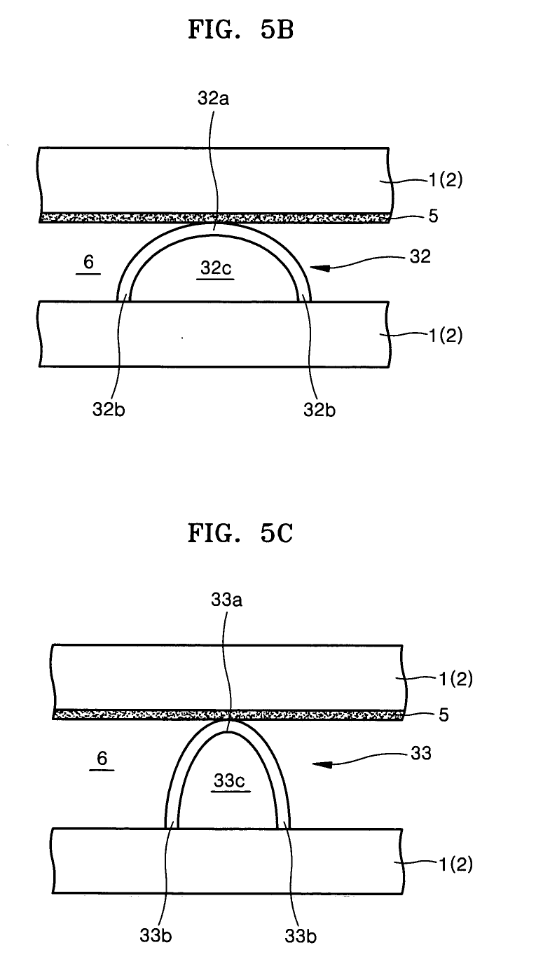

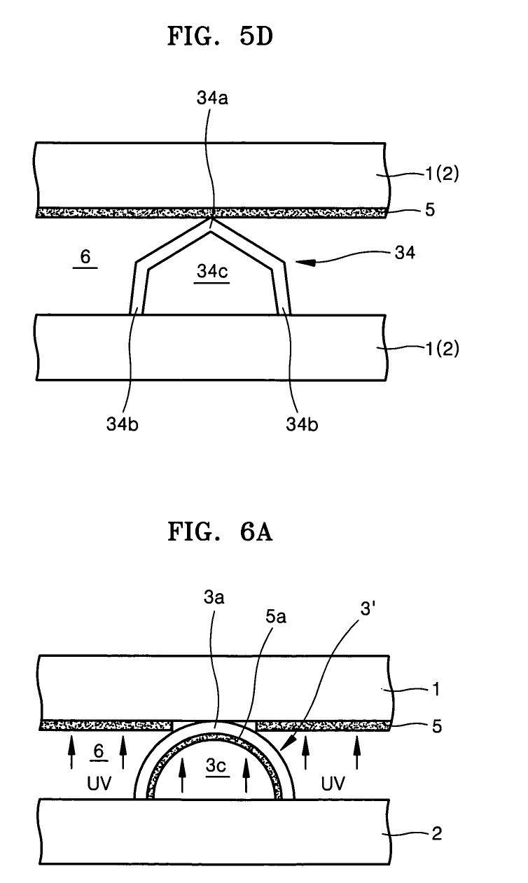

FIGS. 5A through 5D are sectional views illustrating spacers 3 of various shapes. Here, a fluorescent layer 5 is formed on the inner surface of a front plate 1 for the convenience of description. However, the fluorescent layer 5 may be formed on the inner surfaces of the front plate 1 and a rear plate 2 or on the inner surface of the rear plate 2, and the fluorescent layer 5 is formed on the inner surface of the front plate 1, at least. The formation of the fluorescent layer 5 does not limit the scope of the present invention.

A spacer 31 shown in FIG. 5A has a section of a triangular shape with an open side. The spacer 31 includes a first portion 31a contacting the inner surface of a front plate 1 or a rear plate 2 and second portions 31b extending from the first portion 31a and contacting the rear plate 2 or the front plate 1. Accordingly, an inner space 31c having a triangular section is formed inside of the spacer 31.

A spacer 32 shown in FIG. 5B has a section of an oval shape, which is cut along the major axis. The spacer 32 includes a first portion 32a contacting the inner surface of a front plate 1 or a rear plate 2 and second portions 32b extending from the first portion 32a and contacting the rear plate 2 or the front plate 1. Accordingly, an inner space 32c having a semi-oval section with a large width and a small height is formed inside of the spacer 32.

A spacer 33 shown in FIG. 5C has a section of an oval shape, which is cut along the minor axis. The spacer 33 includes a first portion 33a contacting the inner surface of a front plate 1 or a rear plate 2 and second portions 33b extending from the first portion 33a and contacting the rear plate 2 or the front plate 1. Accordingly, an inner space 33c having a semi-oval section with a small width and a large height is formed inside of the spacer 33.

A spacer 34 shown in FIG. 5D has a section of a portion of a polygon having one vertex. The spacer 34 includes a first portion 34a contacting the inner surface of a front plate 1 or a rear plate 2 and second portions 34b extending from the first portion 34a and contacting the rear plate 2 or the front plate 1. Accordingly, an inner space 34c having a polygonal section with a plurality of sides is formed inside of the spacer 34.

FIGS. 5A through 5D are the sectional views illustrating the examples of the spacers that do not limit the scope of the present invention.

Such spacers according to the present invention prevent the problems of the conventional spacers, in other words, the deterioration of partial luminance due to the absorption or block of ultraviolet rays by the spacers. A fluorescent material may be formed on the inner surfaces of the spacers according to the present invention. More specifically, the fluorescent material is suitable to be formed on the inner surfaces of the spacers that are not absorptive of ultraviolet rays.

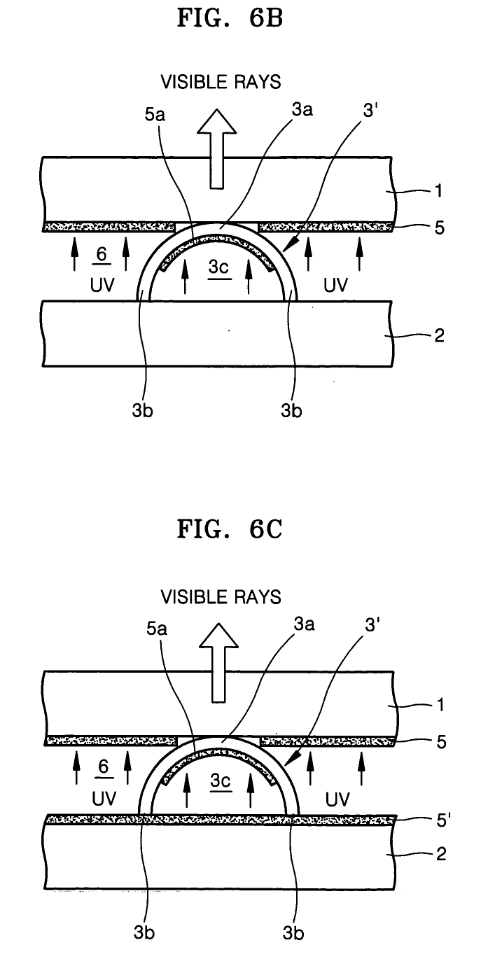

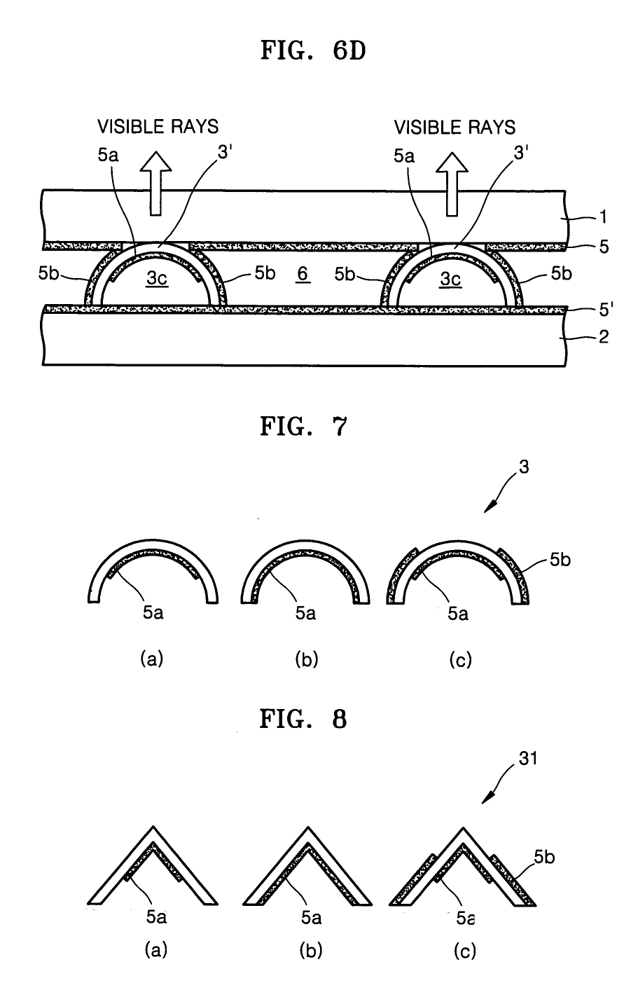

FIGS. 6A through 6D are sectional views illustrating flat lamps to which ultraviolet rays absorptive spacers 3′ are applied. Referring to FIGS. 6A through 6D, a spacer 3′ with a semicircular section is arranged between a front plate 1 and a rear plate 2. Here, the spacer 3′ is formed of glass that is absorptive of ultraviolet rays. The manufacturing cost of such a violet rays absorptive spacer 3′ is lower than that of a spacer 3, which does not absorb violet rays. A fluorescent layer 5a is coated on the inner surface of the spacer 3′, and a fluorescent layer 5 is not formed on a portion of the front plate 1 that contacts a first portion 3a of the spacer 3′. Referring to FIG. 6A, a fluorescent layer 5a is formed on the entire inner surface of a spacer 3′. Referring to FIG. 6B, a fluorescent layer 5a is formed on a portion of the inner surface of a spacer 3′ that is adjacent to a first portion 3a of the spacer 3′. When the fluorescent layer 5 is not formed on a portion of the front plate 1 that contacts the spacer 3′, luminescence is possible due to the fluorescent layer 5a formed on the inner surface of the spacer 3′, so that the partial deterioration of luminance does not occur. Referring to FIG. 6C, a fluorescent layer 5′ is formed on the inner surface of a rear plate 2. As described above, the fluorescent layers may be formed on the inner surface of the rear plate 2 as well as the inner surface of the front plate 1. Moreover, a fluorescent layer 5b may be formed on the outer surface of a spacer 3′ as shown in FIG. 6D.

Since the spacer 3′ has the fluorescent layer 5a, which can emit light, a portion of the fluorescent layer 5 formed on the inner surface of the first plate 1 is removed. FIGS. 7 through 11 are sectional views illustrating ultraviolet rays absorptive spacers that are varied from the spacers of FIGS. 6A through 6D. In FIGS. 7 through 11, spacers denoted by (a) have fluorescent layers on portions of inner surfaces corresponding to first portions of the spacers, spacers denoted by (b) have fluorescent layers on the entire inner surfaces, and spacers denoted by (c) have fluorescent layers on portions of the inner surfaces corresponding to the first portions and on portions of the outer surfaces corresponding to second portions.

Spacers 3 of FIG. 7 have a semicircular section. Here, the spacer 3 denoted by (a) has a fluorescent layer 5a on a portion corresponding to a first portion at the top of the spacer 3, on the inner surface of the spacer 3. The spacer 3 denoted by (b) has a fluorescent layer 5a on the entire inner surface of the spacer 3. The spacer 3 denoted by (c) has a fluorescent layer 5a on a portion corresponding to a first portion at the top of the spacer 3, on the inner surface of the spacer 3, and fluorescent layers 5b on portions corresponding to second portions, on the outer surface of the spacer 3.

Spacers 31 of FIG. 8 have a triangular section with an open side. The spacers 31 denoted by (a), (b), and (c) have fluorescent layers 5a and 5b as described with reference to FIG. 7.

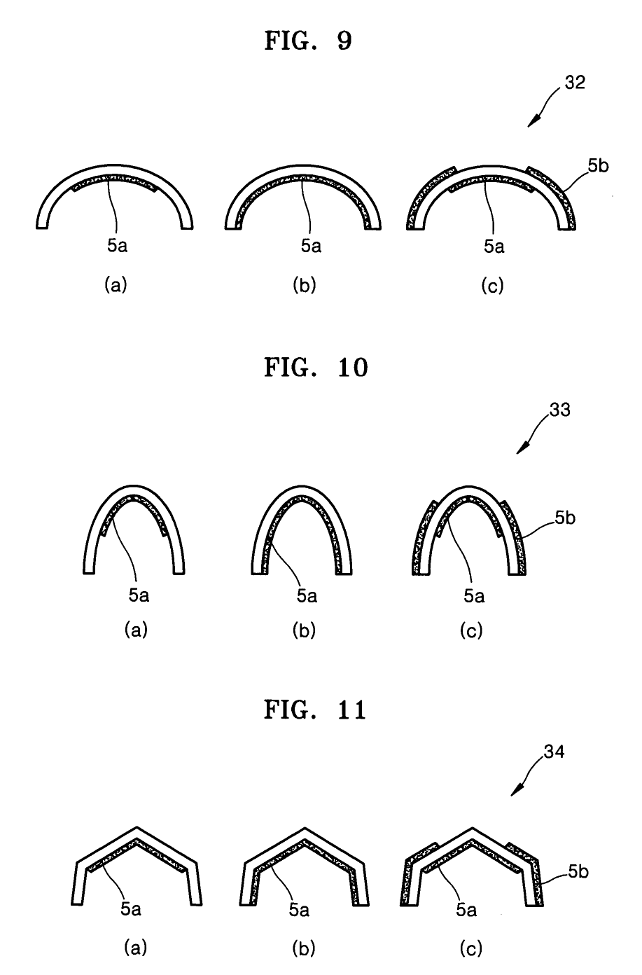

Spacers 32 of FIG. 9 have a section in an oval shape, which is cut along the major axis. The spacers 32 denoted by (a), (b), and (c) have fluorescent layers 5a and 5b as described with reference to FIG. 7.

Spacers 33 of FIG. 10 have a section in an oval shape, which is cut along the minor axis. The spacers 33 denoted by (a), (b), and (c) have fluorescent layers 5a and 5b as described with reference to FIG. 7.

Spacers 34 of FIG. 11 have a section in a portion of a polygonal shape having a vertex. The spacers 34 denoted by (a), (b), and (c) have fluorescent layers 5a and 5b as described with reference to FIG. 7.

The arrangement of electrodes is not fully described above, but it is described that a plurality of electrodes are formed at the outside of the discharge area in the first embodiment of the present invention. However, electrodes may be arranged in a discharge area and protected by a dielectric layer. A flat lamp includes at least two electrodes in any shape as long as forming an electric field of a level that generates a discharge in the discharge area between a front plate and a rear plate. The arrangement and the design of the electrodes do not limit the scope of the present invention.

On the other hand, the spacers may be arranged between the front plate and the rear plate while crossing the space between the front plate and the rear plate, as shown in FIGS. 1A and 2A. In these cases, the spacers may be formed in a perpendicular direction to the electrodes. In addition, the spacers may be partially arranged between the front plate and the rear plate with a predetermined density, as in the case of conventional ball type or column type spacers.

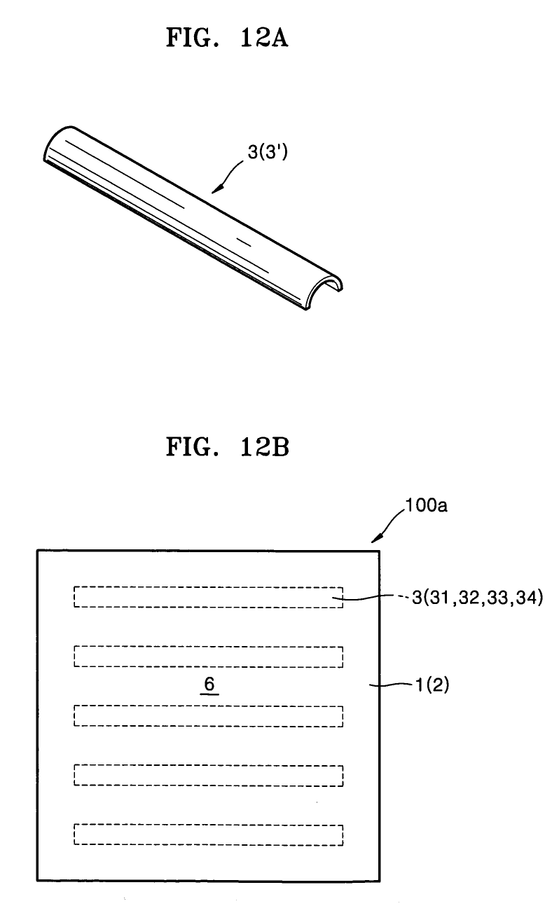

FIG. 12A is a perspective view illustrating a long spacer 3, which crosses a discharge area, and FIG. 12B is a plane view illustrating a flat lamp 100a in which long spacers 3, 31, 32, 33, or 34 are arranged according to a fourth embodiment of the present invention.

As shown in FIG. 12B, the spacers 3, 31, 32, 33, or 34 have a length possible to cross a discharge area in a horizontal direction, and a plurality of spacers 3, 31, 32, 33, or 34 are lined up in the discharge area.

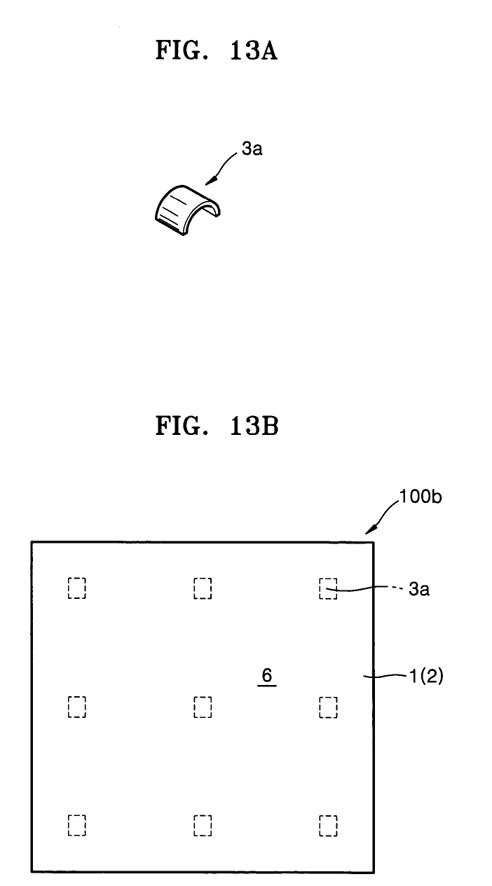

FIG. 13A is a perspective view illustrating a short spacer 3a, which has a section the same as the above-described spacers and a very small length. The short spacers 3a are arranged in a discharge area 6 in a lamp 100b with a predetermined density as shown in FIG. 13B.

A flat lamp having the above-described spacers has a discharge area between a front plate and a rear plate that may be separated into a plurality of areas by barrier walls. Here, such a flat lamp is developed for a large sized LCD. Accordingly, the spacers according to the present invention may be applied to such a flat lamp.

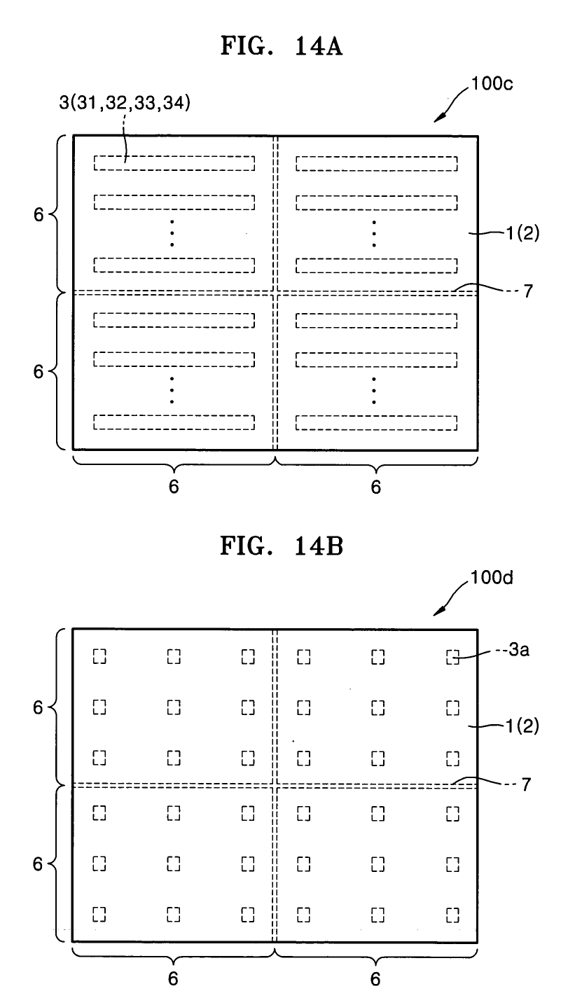

Referring to FIG. 14A, a flat lamp 100c includes a front plate 1 and a rear plate 2, and a discharge area between the front plate 1 and the rear plate 2 is divided into a plurality of discharge areas 6 by barrier walls 7. In the present embodiment, the flat lamp 100c has four discharge areas 6. In addition, a plurality of spacers 3, 31, 32, 33, or 34 according to the present invention are lined up in each discharge area 6.

Referring to FIG. 14B, a flat lamp 100d includes a front plate 1 and a rear plate 2, and a discharge area between the front plate 1 and the rear plate 2 is divided into a plurality of discharge areas 6 by barrier walls 7. A plurality of spacers 3a as shown in FIG. 13B are arranged in each discharge area 6 with a predetermined density.

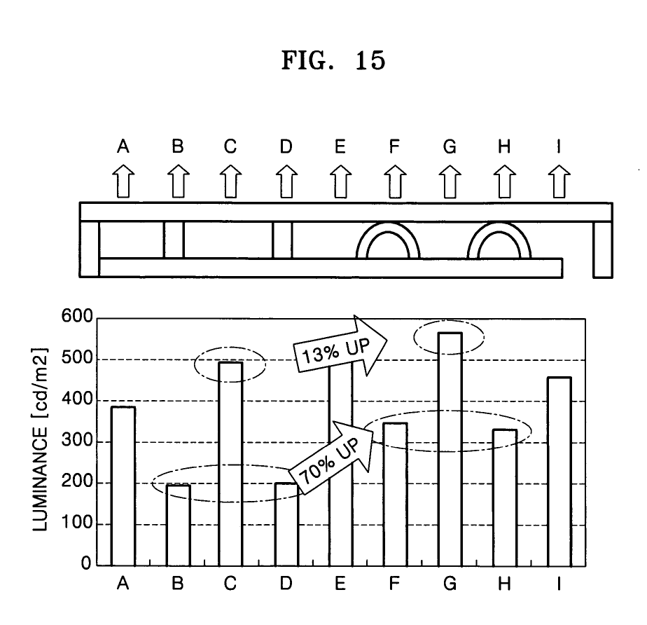

FIG. 15 is a graph of comparing the partial luminescence of a conventional flat lamp with the partial luminescence of a flat lamp according to the present invention.

A sectional view of a flat lamp is shown in the upper part of FIG. 15. Here, areas denoted by “A” through “D” are a conventional flat lamp area where conventional spacers in a simple square section are applied to, and areas denoted by “F” through “I” are a flat lamp area according to the present invention where transmissive spacers in a semicircular section according to the present invention are applied to.

Referring to the graph of FIG. 15, the luminance is lowered in the areas having the spacers. However, the luminance of the flat lamp according to the present invention is higher than the luminance of the conventional flat lamp regardless of the existence of the spacers. The luminance of the areas denoted by “B” and “D” where the conventional spacers are located is 200 cd/m², and the luminance of the areas denoted by “F” and “H” where the semicircular spacers according to the present invention are located is about 350 cd/m², which is improved by more than 70% compared to the conventional flat lamp. In addition, the luminance of the conventional flat lamp at the area denoted by “C” where the spacer is not located is less than 500 cd/m², and the luminance of the flat lamp according to the present invention at the area denoted by “G” where the spacer is not located is 550 cd/m², which is improved by about 13% compared to the conventional flat lamp.

As described above, a flat lamp according to the present invention has spacers in different shapes than conventional spacers. Accordingly, the partial deterioration of luminance and the unevenness of luminance due to the spacers are prevented.

Such a flat lamp according to the present invention can be applied to any device requiring a flat lamp other than the back light of an LCD.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A flat lamp comprising:
a front plate and a rear plate providing a space of a predetermined gap in which a discharge gas is stored;
an electrode unit generating an electric field in a discharge area between the front plate and the rear plate to generate a gas discharge;
a fluorescent layer located in the discharge area for generating visible rays by using ultraviolet rays generated by the gas discharge; and
spacers arranged between the front plate and the rear plate while each spacer having a first portion contacting the inner surface of the front plate or the rear plate and at least two second portions contacting the inner surface of the other plate wherein the second portions extend at least two directions centering around the first portions.

2. The flat lamp of claim 1, wherein the spacers have inner spaces with an open side and fluorescent layers are coated on the inner surfaces of the spacers.

3. The flat lamp of claim 1, wherein each of the spacers has a section in a semicircular shape or an oval shape that has an open side and an inner space.

4. The flat lamp of claim 1, wherein each of the spacers has one open side, one vertex corresponding to the first portion, and the second portions extend from the vertex with a predetermined angle.

5. The flat lamp of claim 1, wherein the spacers have a length of crossing the discharge area and are lined up in the discharge area.

6. The flat lamp of claim 5, wherein the discharge area between the first plate and the second plate is divided into a plurality number of areas and the spacers are arranged in each of the divided areas.

7. The flat lamp of claim 5, wherein the electrode unit includes a plural number of electrodes, which are lined up, and the spacers are arranged in the perpendicular direction to the electrodes.

8. The flat lamp of claim 1, wherein the spacers are arranged in the discharge area with a predetermined density.

9. The flat lamp of claim 8, wherein the discharge area between the first plate and the second plate is divided into a plurality number of areas and the spacers are arranged in the divided areas.

10. The flat lamp of claim 1, wherein the first portion of each of the spacers contacts the inner surface of the front plate and the second portions of each of the spacers contact the inner surface of the rear plate.

11. The flat lamp of claim 2, wherein the first portion of each of the spacers contacts the inner surface of the front plate and the second portions of each of the spacers contact the inner surface of the rear plate, and a fluorescent layer is formed on the inner surface of the front plate except for the portions where the first portions of the spacers contact.

12. The flat lamp of claim 11, wherein the spacers are absorptive of ultraviolet rays.

13. The flat lamp of claim 11, wherein fluorescent layers are coated on the outer surfaces of the spacers.

14. The flat lamp of claim 11, wherein a fluorescent layer is coated on the inner surface of the rear plate.

15. The flat lamp of claim 1, wherein the first portions of the spacers contact the inner surface of the front plate, and a fluorescent layer on the inner surface of the front plate extends to the portions of the inner surface of the front plate that contact the spacers.

16. The flat lamp of claim 15, wherein the spacers are transmissive of ultraviolet rays.
